(19) United States
(12) Patent Application Publication
(10) Pub. No.: US 2026/0318402 A1
(43) Pub. Date: Oct. 15, 2026

(54) BIOTIC DIRECTIONALLY ENHANCED LUBRICATION DIFFERENTIAL FOR NEW ENERGY HEAVY-DUTY VEHICLE AND OPTIMIZATION METHOD THEREFOR

(71) Applicant: Jilin University, Changchun (CN)

(72) Inventors: Chunbao Liu, Changchun (CN); Lu Zhai, Changchun (CN); Konghua Yang, Changchun (CN); Xu Qian, Changchun (CN); Tianyu Sun, Changchun (CN); Jingran Wang, Changchun (CN)

(21) Appl. No.: 19/644,308

(22) Filed: Apr. 10, 2026

(30) Foreign Application Priority Data
Apr. 15, 2025 (CN) 202510468346.2

(51) Int. Cl. F16H 57/04; G06F 30/27

(52) U.S. Cl. CPC F16H 57/0424; F16H 57/0483; G06F 30/27

(57) ABSTRACT

A bionic directionally enhanced lubrication differential for a new energy heavy-duty vehicle includes a differential main body, a shroud enveloping an outer side of the differential main body, and vortex generators arranged on an inner surface of the shroud. An optimal shroud and vortex generator configuration is sought through a dynamic mesh reconstruction calculation method based on a finite volume method (FVM) in Fluent. Furthermore, a back-propagation (BP) neural network is employed to fit experimental data, and multi-objective optimization is performed using particle swarm optimization (PSO), achieving a structural configuration that maximizes flow rate and minimizes drag torque. The present disclosure can achieve radial delivery of external oil against centrifugal gradients into an interior of the enclosed differential, efficiently accomplish an optimal design of shroud configurations, and achieve enhanced lubrication of the differential.

### CROSS-REFERENCE TO RELATED APPLICATION

This application claims priority of Chinese Patent Application No. 202510468346.2, filed on Apr. 15, 2025, the entire contents of which are incorporated herein by reference.

### TECHNICAL FIELD

The present disclosure relates to the technical field of mechanical design, and specifically to a bionic directionally enhanced lubrication differential for a new energy heavy-duty vehicle and an optimization method therefor.

### BACKGROUND

The differential is a key component in automotive drivetrain systems, widely used in conventional fuel vehicles and new energy vehicles, with its role particularly prominent in new energy heavy-duty vehicles. Due to prolonged operation under high-torque and high-load conditions, the differential needs to balance the rotational speed difference between the two wheels in complex scenarios, such as vehicle turning, climbing, and driving on slippery roads. This capability can not only effectively reduce unnecessary tire wear and extend tire service life, but also significantly improve ride comfort, vehicle handling, and safety. However, due to its enclosed and complex structural design, the differential faces challenges in achieving efficient real-time supply of internal lubricating oil. Especially under high-temperature or heavy-load operating conditions, this insufficient oil supply may cause excessive wear of gears and bearings, lubrication failure, or even premature component damage, severely affecting the service life of the differential and the overall vehicle reliability.

Currently, reinforcement measures and optimized design for differential lubrication oil supply issues are still in the development stage. While some studies have attempted to alleviate this issue by improving differential housing structure, optimizing lubrication oil pathways, and enhancing oil performance, these methods have demonstrated insufficient effectiveness under the high-stress environments of new energy heavy-duty vehicles. Consequently, developing efficient lubrication supply technologies, researching specialized lubrication materials for high-load conditions, and exploring intelligent differential health monitoring and maintenance solutions have emerged as current research hotspots and technical focus areas. These improvements can not only enhance the durability and operational stability of the differential but also hold significant importance for optimizing the overall performance of new energy heavy-duty vehicles.

### SUMMARY

In response to the aforementioned issues, the present disclosure provides a bionic directional enhanced lubrication differential for a new energy heavy-duty vehicle and an optimization method therefor. By applying a high-precision turbulence processing method during dynamic mesh reconstruction and implementing multi-objective optimization of structural characteristic dimensions, the present disclosure achieves directional oil supply enhancement for new energy heavy-duty vehicle differentials under high-load conditions.

According to one aspect, the present disclosure provides a bionic directional enhanced lubrication differential for a new energy heavy-duty vehicle, including: a differential main body, a shroud enveloping an outer side of the differential main body, and vortex generators arranged on an inner surface of the shroud, in which: through-holes are disposed on a housing of the differential main body for connecting internal and external oil sumps of the differential; the shroud is configured to surround and envelop the outer side of the differential at an angle of 210°, with a gap maintained between the shroud and the differential; and an arc-shaped oil baffle extends radially inward from an end portion of the shroud along the differential; the vortex generators, configured as protrusion structures, are equidistantly arranged on an inner side of the shroud and configured to generate vortex effects that enhance lubrication performance as lubricating oil flows through; and micro-channel structures are further arranged on a surface of the protrusion structure, and the micro-channel structures are configured as equidistantly arranged rhombic grooves, distributed along a flow direction on the vortex generator.

Alternatively, four through-holes are disposed on the housing of the differential main body and equidistantly arranged in a circumferential pattern.

Alternatively, seven vortex generators are equidistantly arranged on an inner side of the shroud.

Alternatively, the vortex generators include triangular protrusions, arc-shaped protrusions, and trapezoidal protrusions.

Alternatively, the gap maintained between the shroud and the differential main body is set at 5 mm.

According to another aspect, the present disclosure provides an optimization method for the bionic directionally enhanced lubrication differential for a new energy heavy-duty vehicle, including the steps of: establishing differential models with various shroud configurations, including: a configuration without a shroud, a shroud without vortex generators, a shroud equipped with vortex generators, and a shroud equipped with vortex generators incorporating micro-channel structures; establishing a simplified model of the differential using a dynamic mesh reconstruction calculation method based on a finite volume method (FVM) in Fluent, and simulating rotational motion of the differential via dynamic mesh reconstruction; establishing a corresponding monitoring surface at each through-hole on a differential housing; applying the same rotational motion as the differential to the monitoring surfaces; maintaining constant relative positions between the monitoring surfaces and the through-holes during simulation; and reflecting instantaneous flow variations at the through-holes on each differential model housing using real-time flow data from the monitoring surfaces, while monitoring churning drag torque of the entire rotating differential housing; constructing multiple vortex generator configurations, including: triangular vortex generators, arc-shaped vortex generators, and trapezoidal vortex generators, and corresponding variants thereof incorporating micro-channel structures; calculating an average oil exchange volume between the internal and external oil sumps of the differential for each structural model based on computational fluid dynamics (CFD) simulations of the instantaneous flow variation at each through-hole, and selecting a configuration with a maximum oil exchange volume as an optimal shroud and vortex generator configuration; extracting flow field data from the optimal shroud and vortex generator configuration, the flow field data including pressure distributions and velocity vectors; constructing a local computational model for a gap between the shroud and the differential housing based on a fluid flow domain within the gap;

mapping flow field data extracted from the original flow field data onto the local computational model; performing an experimental optimization design on characteristic dimensions of vortex generator configurations based on the local computational model; taking characteristic structural parameters of vortex generators as design variables (including height, top end length, and base angle of the vortex generators); and assigning four values to each characteristic structural parameter within a design range, resulting in a total of 64 vortex generator configurations; positioning the vortex generators directly below, ahead of, and behind housing through-holes, forming three computational models;

establishing a total of 192 computational models based on the 64 vortex generator configurations and the three computational models, and employing a pressure-based CFD numerical simulation method, with a velocity inlet, two pressure outlets, and a rotating wall selected as monitoring surfaces to monitor flow rates at the housing through-holes and shear stress on a housing wall; extracting the final steady-state flow rates at the housing through-holes under the same vortex generator configuration across three positional setups, and taking an average flow rate as a quantitative performance metric for that vortex generator configuration regarding directionally enhanced lubrication; similarly extracting the final steady-state shear stresses on the housing wall under the same vortex generator configuration, and taking an average shear stress as a quantitative performance metric of impact of that vortex generator configuration on churning drag; employing a back-propagation (BP) neural network to fit the characteristic structural parameters of 64 vortex generator configurations with the corresponding quantitative performance metrics (flow rate and drag torque) to obtain a mathematical surrogate model that establishes a relationship between flow rate, drag torque, and the characteristic dimensions of the vortex generator configurations; and performing multi-objective optimization on the characteristic structural parameters of the vortex generators using particle swarm optimization (PSO), to obtain a structural configuration that maximizes flow rate and minimizes drag torque.

Alternatively, the mapping flow field data extracted from the original flow field data onto the local computational model includes the steps of: applying the corresponding velocity vectors from the original flow field data as a fitting function to radial velocity distributions at the velocity inlet of the local computational model; imposing the pressure distributions via a fitting function onto tangential pressure distributions at corresponding through-hole positions; and applying the pressure distributions through a fitting function to the radial pressure distributions at corresponding outlet positions.

The present disclosure has the following beneficial effects.

Based on the coupled configuration of the shroud and vortex generators for near-wall oil flow regulation in the differential, the present disclosure can achieve the radial transport of external oil against centrifugal gradients into an interior of the differential, enhancing the lubrication of internal components and improving wear conditions of differential internal parts. Using the through-holes on the housing of the differential main body, lubricating oil can freely flow between the internal and external oil sumps of the differential, ensuring adequate lubrication of the interior of the differential. The vortex generators on the inner surface of the shroud can generate vortex effects, enhancing the turbulence level of the oil and improving the lubrication effectiveness of the lubricating oil. The micro-channel structures on the surfaces of the vortex generators can achieve smaller flow resistance, reducing flow losses in the flow field within the gap between the differential housing and the shroud to achieve a larger directional oil supply volume.

Based on the aforementioned structure, the present disclosure further provides an optimization method to accomplish the optimal design of shroud configurations for maximizing lubrication performance. By adopting a dynamic mesh reconstruction calculation method based on FVM in Fluent, a numerical computation model for simulating churning values of the differential shroud is established. Additionally, a local numerical computation model based on flow field data is constructed, which reduces computational costs and time while accurately reflecting flow field characteristics of the original model. Combining a BP neural network-based mathematical model with a PSO optimization scheme can facilitate more accurate and efficient identification of optimal vortex generator configurations.

### BRIEF DESCRIPTION OF THE DRAWINGS

The accompanying drawings herein are provided to facilitate a better understanding of the present disclosure and constitute a part of this specification. The illustrative embodiments of the present disclosure and the descriptions thereof are intended to explain the present disclosure and are not to be construed as unduly limiting the present disclosure. In the accompanying drawings:

FIG. 1A is a front view of a bionic directional enhanced lubrication differential model for a new energy heavy-duty vehicle;

FIG. 1B is an axial sectional view of the differential model at housing through-holes 1.1;

FIG. 1C is an isometric view of the differential model; and

FIG. 1D is a partial enlarged view of a vortex generator 3.

FIG. 2A is an isometric view of a local computational model; and

FIG. 2B is a side view of the local computational model.

FIG. 3 is a partial isometric view of a micro-channel structure.

Reference numerals and denotations thereof: 1-differential main body; 1.1-through-hole; 2-shroud; 3-vortex generator; 8-oil baffle; 4-velocity inlet; 5-first pressure outlet; 6-second pressure outlet; 7-rotating wall; and 9-micro-channel structure.

### DETAILED DESCRIPTION

To facilitate a better understanding of the solutions of the present application by those of skill in the art, the technical solutions in the embodiments of the present application are further described clearly and completely below in combination with the accompanying drawings. Obviously, the embodiments are only part of the embodiments of the present application, rather than all embodiments. Based on the embodiments of the present application, all other embodiments obtained by those of ordinary skill in the art without creative efforts fall within the scope of protection of the present application. It is to be noted that the embodiments of the present application and features therein may be mutually combined without technical conflict.

Furthermore, the terms "an embodiment" or "embodiment" as used herein refer to specific features, structures, or characteristics that may be incorporated in at least one implementation of the present disclosure. The phrase "in one embodiment" appearing at various places in this specification does not necessarily all refer to the same embodiment, nor are they separate or alternative embodiments that are mutually exclusive from other embodiments.

Furthermore, the terms "include," "have", and any variants thereof in the specification and claims of the present application are intended to cover a non-exclusive inclusion. For example, a process, method, product, or device that includes a series of steps or units is not necessarily limited to those expressly listed steps or units, but may include other steps or units not expressly listed or inherent to such process, method, product, or device.

Embodiment 1: this embodiment of the present disclosure provides a bionic directional enhanced lubrication differential for a new energy heavy-duty vehicle, which aims to achieve enhanced lubrication of the differential through an enveloping shroud on an outer side of the differential and vortex generators on an inner surface of the shroud (with micro-channel structures also arranged on surfaces of the vortex generators).

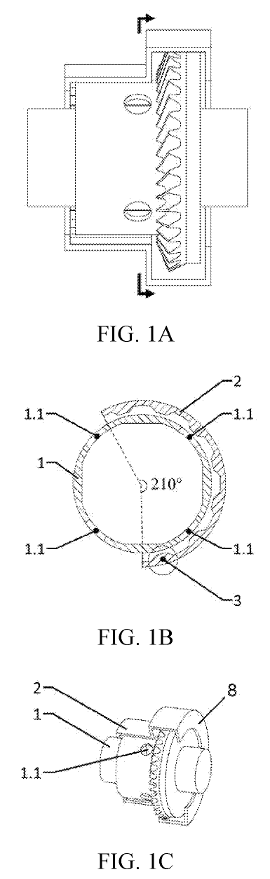

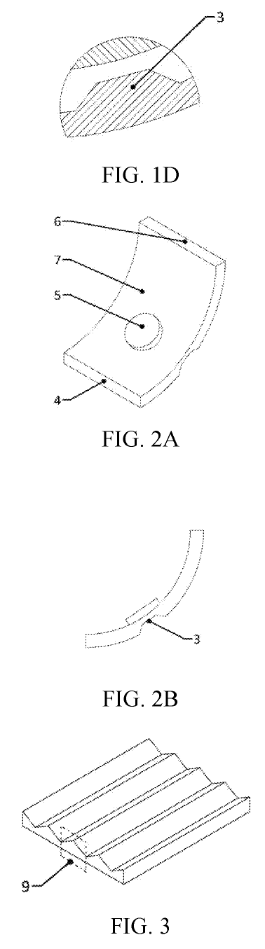

Referring to FIG. 1, the differential includes a differential main body 1, a shroud 2 enveloping an outer side of the differential main body 1, and vortex generators 3 arranged on an inner surface of the shroud 2, in which:

Four through-holes 1.1 are disposed on a housing of the differential main body 1, equidistantly distributed around a circumference of a differential housing. Through these through-holes 1.1, lubricating oil can freely flow between an interior of the differential and an external oil sump, ensuring adequate lubrication of internal components and achieving lubricant circulation and cooling. The equidistant circumferential distribution of through-holes 1.1 facilitates uniform and stable lubricant flow between internal and external oil sumps of the differential, thereby achieving consistent lubrication performance.

The shroud 2 is open-type semi-enclosed and is configured to surround and envelope the outer side of the differential main body 1 at a 210° angle. A starting position of an enveloping surface is set directly below the differential, with consideration given to the circumferential oil intake efficiency between the differential housing and the shroud. A gap between the shroud 2 and the differential main body 1 is set at 5mm. This gap ensures that lubricating oil forms a stable oil film along a surface of the differential housing under centrifugal force, while avoiding oil splashing losses caused by excessive gap. Considering pressure maintenance requirements in a target area for directionally enhanced lubrication of the differential, the shroud 2 needs to axially envelop a cylindrical surface of the differential housing and a gear pair position, as shown in FIGS. 1A and 1C. The shroud 2 adopts a segmented cylindrical housing design, including two cylindrical sections: one enveloping the cylindrical surface of the differential housing and the other enveloping the gear pair position. Additionally, an arc-shaped oil baffle 8 extends radially inward from an end portion of the shroud 2 along the differential.

The vortex generator 3 is configured as a protrusion structure, as shown in FIG. 1B. Seven trapezoidal vortex generators 3 are equidistantly spaced at 25° intervals on an inner side of the shroud 2. When lubricating oil flows through, the vortex generators 3 generate vortex effects that enhance the turbulence level of the oil, increase the contact area and contact time between lubricating oil and differential components, and improve the distribution uniformity and lubrication effectiveness of lubricating oil.

In other embodiments, the vortex generator 3 may adopt alternative protrusion structure types, such as triangular, arc-shaped, or other configurations. Triangular protrusions feature a sharp apex capable of generating intense vortex flows; arc-shaped protrusions exhibit smoother flow characteristics that reduce lubricant drag while maintaining vortex generation; and trapezoidal protrusions can produce a pair of oppositely phased vortex structures, enhancing the mixing efficiency of lubricating oil.

Furthermore, micro-channel structures 9 are further arranged on a surface of the vortex generator 3, as shown in FIG. 3. The micro-channel structures 9 are configured as equidistantly arranged rhombic grooves, distributed along a flow direction on the vortex generator 3. By incorporating the micro-channel structures 9, the flow state of lubricating oil can be further modified to form more complex and effective flow patterns during fluid movement, thereby enhancing the turbulence-inducing capability of the vortex generator 3.

This embodiment of the present disclosure achieves efficient lubricant flow and heat dissipation through the through-holes on the differential, the enveloping shroud on the outer side of the differential, and the vortex generators on the inner surface of the shroud, thereby enhancing the lubrication performance and operational efficiency of the differential.

Embodiment 2

This embodiment of the present disclosure provides an optimization method for a bionic directionally enhanced lubrication differential for a new energy heavy-duty vehicle, aimed at building upon the structural foundation provided in Embodiment 1. This method further achieves lubrication performance maximization through fine-tuning of structural parameters of the differential, particularly configurations of the vortex generators. Specifically, the method includes the following steps:

In S1, differential models with various shroud configurations are established, including: a configuration without a shroud, a shroud without vortex generators, a shroud equipped with vortex generators, and a shroud equipped with vortex generators incorporating micro-channel structures.

In this step, differential models with four shroud configurations are established as follows:
a. a configuration without a shroud;
b. a shroud configuration without vortex generators;
c. a shroud configuration with vortex generators; and
d. a shroud configuration equipped with vortex generators incorporating micro-channel structures.

Flow data from configurations a and b can validate the shroud's influence on near-wall flow behavior in the differential; flow data from configurations b and c can verify the vortex generators' role in radial flow regulation; and changes in churning drag torque between configurations c and d can demonstrate the micro-channel structures' drag reduction effect on near-wall flow in the differential.

In S2, a simplified model of the differential is established using a dynamic mesh reconstruction calculation method based on a finite volume method (FVM) in Fluent, and rotational motion of the differential is simulated via dynamic mesh reconstruction.

The simplified model of the differential involves simplifying the differential housing to a single cylindrical body, retaining a main reduction gear pair component, sealing half-shaft holes at two ends of the differential housing, and creating a plurality of through-holes 1.1 (four through-holes in this embodiment) on the cylindrical section of the differential housing. To reduce computational costs, internal differential components are removed, and internal mating structures such as bosses and grooves are eliminated.

In S3, a corresponding monitoring surface is established at each through-hole on the differential housing, with four through-holes corresponding to four monitoring surfaces. The same rotational motion as the differential is applied to the monitoring surfaces, maintaining constant relative positions between the monitoring surfaces and the through-holes during simulation. Instantaneous flow variations at the through-holes 1.1 of each differential model housing are reflected using real-time flow data from the monitoring surfaces, while monitoring churning drag torque of the entire rotating differential housing.

In S4, six vortex generator configurations are constructed, including: triangular vortex generators, arc-shaped vortex generators, and trapezoidal vortex generators, and corresponding variants thereof incorporating micro-channel structures (specifically including: the triangular vortex generators, the arc-shaped vortex generators, the trapezoidal vortex generators, triangular vortex generators with micro-channel structures, arc-shaped vortex generators with micro-channel structures, and trapezoidal vortex generators with micro-channel structures).

It is to be noted that for each vortex generator configuration, the characteristic dimensions (e.g., length, height) of all individual vortex generators need to remain uniform.

In S5, an average oil exchange volume is calculated between the internal and external oil sumps of the differential for each structural model based on computational fluid dynamics (CFD) simulations of the instantaneous flow variation at each through-hole, and a configuration with a maximum oil exchange volume is selected as an optimal shroud and vortex generator configuration.

In S6, flow field data is extracted from the optimal shroud and vortex generator configuration. The flow field data includes pressure distributions and velocity vectors, with particular attention given to the pressure distributions and velocity vectors at the end face where the shroud envelopment gap is in communication with the external oil sump, as well as at the four through-holes.

In S7, a local computational model is constructed for a gap between the shroud and the differential housing based on a fluid flow domain within the gap.

As shown in FIG. 2, which is a schematic diagram of the local computational model, the model represents the fluid flow domain within the gap between the differential housing and the shroud.

In S8, flow field data extracted from the original flow field data is mapped onto the local computational model.

Pressure and velocity data from the original flow field are mapped onto inlet and outlet surfaces of the local computational model, in which 4 denotes a velocity inlet, 6 denotes a second pressure outlet, and the rotating wall 7 is configured as a moving surface. This rotating wall rotates uniformly about the geometric curvature direction from the velocity inlet 4 towards the second pressure outlet 6, replicating the original flow field characteristics. Specifically, the corresponding velocity vectors from the original flow field data are applied as a fitting function to radial velocity distributions at the velocity inlet of the local computational model; the pressure distributions are imposed via a fitting function onto tangential pressure distributions at corresponding through-hole positions; and the pressure distributions are applied through a fitting function to the radial pressure distributions at corresponding outlet positions.

In S9, an experimental optimization design is performed on characteristic dimensions of vortex generator configurations based on the local computational model; characteristic structural parameters of vortex generators are taken as design variables (including height, top end length, and base angle of the vortex generators); and four values are assigned to each characteristic structural parameter within a design range, resulting in a total of 64 vortex generator configurations (4 lengths × 4 heights × 4 inclination angles).

In S10, the vortex generators are positioned directly below, ahead of, and behind housing through-holes, forming three computational models.

In S11, a total of 192 computational models are established based on the 64 vortex generator configurations and the three computational models. A pressure-based CFD numerical simulation method is employed, and a velocity inlet, two pressure outlets, and a rotating wall are selected as monitoring surfaces to monitor flow rates at the housing through-holes (i.e., the volumetric flow rate at a first pressure outlet 5) and shear stress on a housing wall (i.e., the rotating wall 7).

In S12, the final steady-state flow rates are extracted at the housing through-holes under the same vortex generator configuration across three positional setups, and an average flow rate is taken as a quantitative performance metric for that vortex generator configuration regarding directionally enhanced lubrication.

In S13, the final steady-state shear stress is similarly extracted on the housing wall under the same vortex generator configuration, and an average shear stress is taken as a quantitative performance metric of impact of that vortex generator configuration on churning drag.

In S14, a back-propagation (BP) neural network is employed to fit the characteristic structural parameters of 64 vortex generator configurations with the corresponding quantitative performance metrics (flow rate and drag torque), thereby obtaining a mathematical surrogate model that establishes a relationship between flow rate, drag torque, and the characteristic dimensions of the vortex generator configurations.

This mathematical surrogate model can be implemented using a fitting function available in Matlab.

In S15, multi-objective optimization is performed on the characteristic structural parameters of the vortex generators using particle swarm optimization (PSO), thereby obtaining a structural configuration that maximizes flow rate and minimizes drag torque.

Through the aforementioned steps, Embodiment 2 of the present disclosure has optimized the structural parameters of the bionic directionally enhanced lubrication differential for a new energy heavy-duty vehicle, identified the optimal shroud and vortex generator configuration, and consequently improved the differential's lubrication performance.

The foregoing is only the preferred embodiment of the present disclosure. It is to be noted that a person of ordinary skill in the art may make several improvements and embellishments without departing from the principle of the present disclosure, and these improvements and embellishments are regarded as falling within the scope of protection of the present disclosure.

1. An optimization method for a bionic directionally enhanced lubrication differential for a new energy heavy-duty vehicle, applied to the bionic directionally enhanced lubrication differential for a new energy heavy-duty vehicle, the differential comprising:
a differential main body, a shroud enveloping an outer side of the differential main body, and vortex generators arranged on an inner surface of the shroud;
wherein
through-holes are disposed on a housing of the differential main body for connecting internal and external oil sumps of the differential;
the shroud is configured to surround and envelop the outer side of the differential at an angle of 210°, with a gap maintained between the shroud and the differential; and an arc-shaped oil baffle extends radially inward from an end portion of the shroud along the differential;
the vortex generators, configured as protrusion structures, are equidistantly arranged on an inner side of the shroud and configured to generate vortex effects that enhance lubrication performance as lubricating oil flows through;
micro-channel structures are further arranged on a surface of the protrusion structure, and the micro-channel structures are configured as equidistantly arranged rhombic grooves, distributed along a flow direction on the vortex generator;
four through-holes are disposed on the housing of the differential main body and equidistantly arranged in a circumferential pattern;
seven vortex generators are equidistantly arranged on an inner side of the shroud;
the vortex generators comprise triangular protrusions, arc-shaped protrusions, and trapezoidal protrusions; and
the gap maintained between the shroud and the differential main body is set at 5 mm; and
the optimization method comprises the steps of:
establishing differential models with various shroud configurations, comprising: a configuration without a shroud, a shroud without vortex generators, a shroud equipped with vortex generators, and a shroud equipped with vortex generators incorporating micro-channel structures;
establishing a simplified model of the differential using a dynamic mesh reconstruction calculation method based on a finite volume method (FVM) in Fluent, and simulating rotational motion of the differential via dynamic mesh reconstruction;
establishing a corresponding monitoring surface at each through-hole on a differential housing; applying the same rotational motion as the differential to the monitoring surfaces; maintaining constant relative positions between the monitoring surfaces and the through-holes during simulation; and reflecting instantaneous flow variations at the through-holes on each differential model housing using real-time flow data from the monitoring surfaces, while monitoring churning drag torque of the entire rotating differential housing;
constructing multiple vortex generator configurations, comprising: triangular vortex generators, arc-shaped vortex generators, and trapezoidal vortex generators, and corresponding variants thereof incorporating micro-channel structures;
calculating an average oil exchange volume between the internal and external oil sumps of the differential for each structural model based on computational fluid dynamics (CFD) simulations of the instantaneous flow variation at each through-hole, and selecting a configuration with a maximum oil exchange volume as an optimal shroud and vortex generator configuration;
extracting flow field data from the optimal shroud and vortex generator configuration, the flow field data comprising pressure distributions and velocity vectors;
constructing a local computational model for a gap between the shroud and the differential housing based on a fluid flow domain within the gap;
mapping flow field data extracted from the original flow field data onto the local computational model;
performing an experimental optimization design on characteristic dimensions of vortex generator configurations based on the local computational model; taking characteristic structural parameters of vortex generators as design variables (comprising height, top end length, and base angle of the vortex generators); and assigning four values to each characteristic structural parameter within a design range, resulting in a total of 64 vortex generator configurations;
positioning the vortex generators directly below, ahead of, and behind housing through-holes, forming three computational models;
establishing a total of 192 computational models based on the 64 vortex generator configurations and the three computational models, and employing a pressure-based CFD numerical simulation method, with a velocity inlet, two pressure outlets, and a rotating wall selected as monitoring surfaces to monitor flow rates at the housing through-holes and shear stress on a housing wall;
extracting the final steady-state flow rates at the housing through-holes under the same vortex generator configuration across three positional setups, and taking an average flow rate as a quantitative performance metric for that vortex generator configuration regarding directionally enhanced lubrication;
similarly extracting the final steady-state shear stresses on the housing wall under the same vortex generator configuration, and taking an average shear stress as a quantitative performance metric of impact of that vortex generator configuration on churning drag;
employing a back-propagation (BP) neural network to fit the characteristic structural parameters of 64 vortex generator configurations with the corresponding quantitative performance metrics (flow rate and drag torque) to obtain a mathematical surrogate model that establishes a relationship between flow rate, drag torque, and the characteristic dimensions of the vortex generator configurations; and
performing multi-objective optimization on the characteristic structural parameters of the vortex generators using particle swarm optimization (PSO), to obtain a structural configuration that maximizes flow rate and minimizes drag torque.

2. The optimization method for a bionic directionally enhanced lubrication differential for a new energy heavy-duty vehicle according to claim 1, wherein the mapping flow field data extracted from the original flow field data onto the local computational model comprises the steps of:
applying the corresponding velocity vectors from the original flow field data as a fitting function to radial velocity distributions at the velocity inlet of the local computational model;
imposing the pressure distributions via a fitting function onto tangential pressure distributions at corresponding through-hole positions; and
applying the pressure distributions through a fitting function to the radial pressure distributions at corresponding outlet positions.
